(19) United States
(12) Patent Application Publication
(10) Pub. No.: US 2022/0064999 A1
(43) Pub. Date: Mar. 3, 2022

(54) Intelligent Lock and Latch Control System

(71) Applicants: Grayson Allen, Mesa, AZ (US); Kevin Hale, Mesa, AZ (US); Curtis MacKay, Mesa, AZ (US)

(72) Inventors: Grayson Allen, Mesa, AZ (US); Kevin Hale, Mesa, AZ (US); Curtis MacKay, Mesa, AZ (US)

(73) Assignee: Halen LLC, Mesa, AZ (US)

(21) Appl. No.: 17/346,611

(22) Filed: Jun. 14, 2021

Related U.S. Application Data
(63) Continuation of application No. PCT/US20/13759, filed on Jan. 15, 2020.
(60) Provisional application No. 62/792,601, filed on Jan. 15, 2019.

(51) Int. Cl. E05B 65/00; E05C 3/30; E05B 15/00; E05B 47/00

(52) U.S. Cl. CPC E05B 65/0007; E05C 3/30; E05B 2047/0095; E05B 47/0012; E05B 2047/0076; E05B 15/0093

(57) ABSTRACT

An intelligent lock and latch system which may include a housing that can be coupled to a post. The system employs a latch pin that can coupled to a gate and used in connection with the housing to secure the gate. The housing can further comprise a front cavity, a back cavity, one or more mounting holes, a slot, and a recess. The housing can be coupled to the post by one or more fasteners through the housing's mounting holes or using a mounting adapter. The intelligent lock and latch system can further comprise a back cover supporting gears, an electrical system and motor to power the gears, and a keypad to operate the system that be a standalone system or can communicate through wireless communication to a hub or mobile device.

### CROSS-REFERENCE TO RELATED APPLICATIONS

This application claims benefit from currently pending PCT Application No. PCT/US20/13759, titled “Intelligent Lock and Latch Control System” and having a filing date of Jan. 15, 2020, which claims benefit from U.S. Provisional Application No. 62/792,601 having a filing date of Jan. 15, 2019, each of which is incorporated by reference herein.

### TECHNICAL FIELD

The present specification relates to a lock and latch control system, more particularly an intelligent lock and latch control system for alerting a user, and securing a gate door.

### BACKGROUND

Various types of locks or locking mechanisms have been developed for locking gates, fences, pool fences, barn doors, cattle gates, and storage units shut. Gate locks typically consist of a gravity latch, gravity latch housing, and a keeper pin wherein the bolt can activate the gravity latch when the gate or fence is closed, depressing the gravity latching mechanism, which is pivotally mounted onto the gravity latch housing, and then enclosing a portion of the keeper pin, locking the gate onto a stationary fence pole. The gravity latch can be locked into the gravity latch housing by attaching a padlock, or combination lock through a hole on the bottom portion of the gravity latch housing. However, if a padlock is not attached to the gravity latch housing then the gravity latch can be easily opened.

U.S. Pat. No. 8,376,421 shows a magnetic gate latching device mounted to a fence post including a latch assembly, and a keeper assembly to control access to a pool area. The magnetic gate latching device upper latch may include an actuator coupled to a lower latch assembly, and the upper latch actuator can include an actuator pull knob member which can provide a visual indication of the position of the lower latch. The keeper assembly can include a latch base which can have a latch arm which can be attached to a gate. The latch arm can have a latch pin recess configured to receive the latch pin and a magnet recess to retain a vertically disposed magnet.

Typically, a homeowner, business owner or other gate user chooses a gate locking system that will keep a pool gate, side gate, cattle gate, or barn doors shut and locked. These types of gate locking systems are waterproof, and usually made from high strength material that can resist the elements and which can be simply operated in connection with a padlock or dial lock to protect the contents. All these locks have a mechanical element to keep the gate or door shut, but require an additional element to lock it. In addition, current gate locking systems require the user to visually check the status of the gate and whether it has been shut, or if someone has tampered with the gate. If the user is not at home then there is no way of providing feedback from these gate locking systems.

It would be advantageous to provide an intelligent lock and latch control system that enables a user to be connected to their gate, is waterproof, locks the gate, and can inform the user of the status of the gate from remote locations.

### SUMMARY

Aspects disclosed herein comprise an intelligent lock and latch system for use with a gravity latch secured to a post and a latch pin secured to a gate, the intelligent latch and lock system comprising a housing that can be secured to the post. The housing can have a recess to accommodate the latch pin and a cutout to accommodate the gravity latch. A locking pin can selectively transverses the recess to prevent the latch pin from exiting the recess. The housing can further comprise a back cavity encompassing a motor coupled to the locking pin that can selectively move the locking pin from an open position to a locked position. The motor can be coupled to the locking pin via at least one gear.

The housing can further comprise a front cavity accessible to a user when the housing is secured to the post. The front cavity can store a power supply. The housing can further comprise a push button hole wherein the push button hole can have a push button contained within it. The front cavity and the back cavity can be sealed shut with a front seal and a front cover, and a back seal and a back cover wherein the front seal and back seal are fastened to the housing. The back cover comprises gear supports. The housing encompasses an electrical system wherein the electrical system can connect remotely to a home hub and/or computing device. The electrical system can connect remotely to a keypad. A user can input a code into a keypad wherein the code can be multi-digit code that can be stored on the intelligent lock and latch system, or it can be stored on the home hub. A user can set or update the code on a computing device wherein the computing device can have a mobile application installed on it that can be programmed to send the set or updated code to the intelligent lock and latch system or the home hub.

Aspects and applications of the invention presented here are described below in the drawings and detailed description of the invention. Unless specifically noted, it is intended that the words and phrases in the specification and the claims be given their plain, ordinary, and accustomed meaning to those of ordinary skill in the applicable arts. The inventors are fully aware that they can be their own lexicographers if desired. The inventors expressly elect, as their own lexicographers, to use only the plain and ordinary meaning of terms in the specification and claims unless they clearly state otherwise and then further, expressly set forth the. Absent such clear statements of intent to apply a “special” definition, it is the inventor's intent and desire that the simple, plain, and ordinary meaning to the terms be applied to the interpretation of the specification and claims.

The inventors are also aware of the normal precepts of English grammar. Thus, if a noun, term, or phrase is intended to be further characterized, specified, or narrowed in some way, then such noun, term, or phrase will expressly include additional adjectives, descriptive terms, or other modifiers in accordance with the normal precepts of English grammar. Absent the use of such adjectives, descriptive terms, or modifiers, it is the intent that such nouns, terms, or phrases be given their plain, and ordinary English meaning to those skilled in the applicable arts as set forth above.

Further, the inventors are fully informed of the standards and application of the special provisions of 35 U.S.C. § 112 (f). Thus, the use of the words “function,” “means” or “step” in the Detailed Description or Description of the Drawings or claims is not intended to somehow indicate a desire to invoke the special provisions of 35 U.S.C. § 112 (f), to define the invention. To the contrary, if the provisions of 35 U.S.C. § 112 (f) are sought to be invoked to define the inventions, the claims will specifically and expressly state the exact phrases “means for” or “step for”, and will also recite the word “function” (i.e., will state “means for performing the function of molding a fishing lure, without also reciting in such phrases any structure, material or act in support of the function. Thus, even when the claims recite a “means for performing the function of molding a fishing lure, step for performing the function of molding a fishing lure,” if the claims also recite any structure, material or acts in support of that means or step, or that perform the recited function, then it is the clear intention of the inventors not to invoke the provisions of 35 U.S.C. § 112 (f). Moreover, even if the provisions of 35 U.S.C. § 112 (f) are invoked to define the claimed inventions, it is intended that the inventions not be limited only to the specific structure, material or acts that are described in the preferred embodiments, but in addition, include any and all structures, materials or acts that perform the claimed function as described in alternative embodiments or forms of the invention, or that are well known present or later-developed, equivalent structures, material or acts for performing the claimed function.

Additional features and advantages of the present specification will become apparent to those skilled in the art upon consideration of the following detailed description of the illustrative embodiment exemplifying the best mode of carrying out the invention as presently perceived.

### BRIEF DESCRIPTION OF THE DRAWINGS

These and other features, aspects, and advantages of the present specification will become better understood with regard to the following description, appended claims, and accompanying drawings where:

FIG. 1 is a front-isometric view of an intelligent lock and latch system in accordance to one, or more embodiments;

FIG. 2a is a front-isometric exploded view of an intelligent lock and latch system in accordance to one, or more embodiments;

FIG. 2b is a front-isometric exploded view of an intelligent lock and latch system in accordance to one, or more embodiments;

FIG. 2c is a back-isometric exploded view of an intelligent lock and latch system in accordance to one, or more embodiments;

FIG. 2D is a back view with back cover omitted of an intelligent lock and latch system in accordance to one, or more embodiments;

FIG. 3 is an isometric view of an intelligent lock and latch system and keypad in accordance to one, or more embodiments;

FIG. 4 is a flow diagram of an intelligent lock and latch system and communicating remotely to a user in accordance to one, or more embodiments;

FIG. 5 is an example flow process of an intelligent lock and latch system in accordance to one, or more embodiments;

FIG. 6 is an exploded isometric view of another embodiment of an intelligent lock and latch system in accordance to one or more embodiments; and

FIG. 7 is an exploded side view of another embodiment of an intelligent lock and latch system in accordance to one, or more embodiments.

FIG. 8 is another exploded isometric view of another embodiment of an intelligent lock and latch system in accordance to one, or more embodiments.

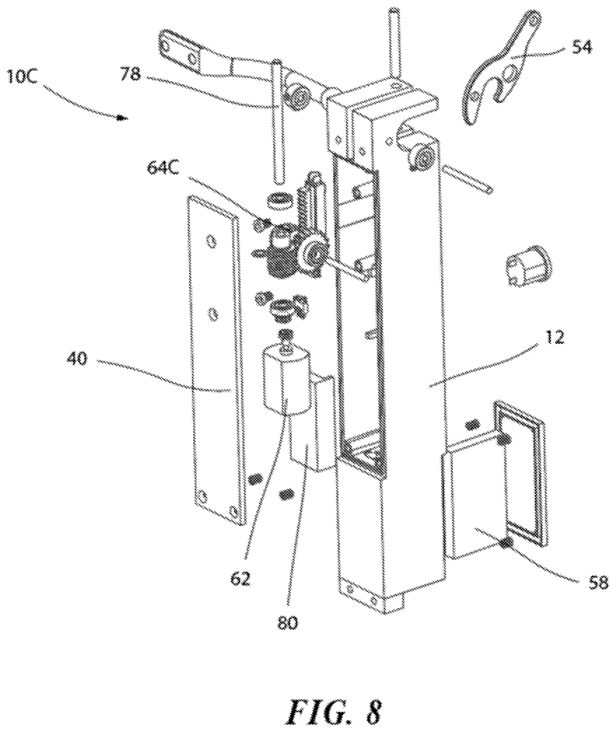

FIG. 9 is an isometric view of an assembled keypad embodiment of an intelligent lock and latch system in accordance to one, or more embodiments.

FIG. 10 is a side view of the embodiment of FIG. 9.

FIG. 11 is an exploded isometric view of the embodiment of FIG. 9

FIG. 12 is an interior side view of the embodiment of FIG. 9

FIG. 13 a flow diagram of an intelligent lock and latch system and communicating remotely to a user in accordance to one, or more embodiments

### DETAILED DESCRIPTION

In the following description, and for the purposes of explanation, numerous specific details are set forth in order to provide a thorough understanding of the various aspects of the invention. It will be understood, however, by those skilled in the relevant arts, that the present invention may be practiced without these specific details. In other instances, known structures and devices are shown or discussed more generally in order to avoid obscuring the invention. In many cases, a description of the operation is sufficient to enable one to implement the various forms of the invention, particularly when the operation is to be implemented in software. It should be noted that there are many different and alternative configurations, devices and technologies to which the disclosed inventions may be applied. The full scope of the inventions is not limited to the examples that are described below.

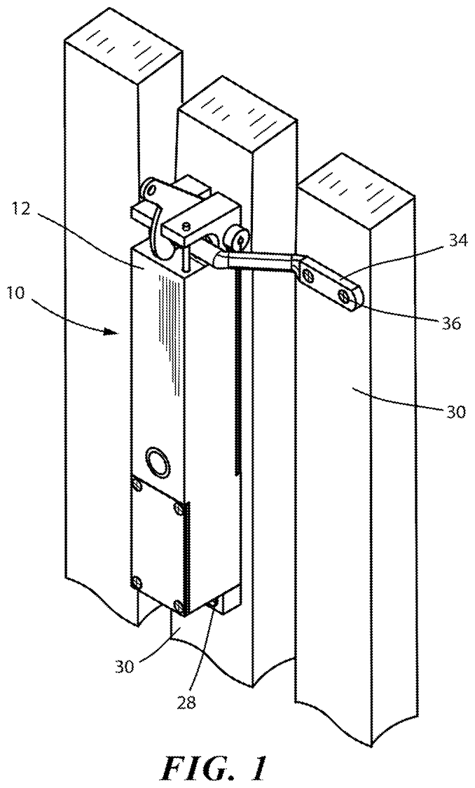

Referring initially to FIG. 1, an isometric view of an intelligent lock and latch system is shown generally at 10. The intelligent lock and latch system 10 can comprise a housing 12 wherein the housing can be coupled with a housing plurality of fasteners 28 to a post 30. The post 30 can be such as, but not limited to, a barn wall, cattle gate, a pool gate, farm gate, side yard gate, and the like. The intelligent lock and latch system 10 can further comprise a latch pin 34 wherein the latch pin can be coupled to a gate 32 by a gate plurality of fasteners 36, wherein the gate can be such as, for example, swinging gate, barn door, cattle gate, pool gate, fence gate, construction post, farm gate post, or the like. The latch pin 34 can be such as, for example, gate latch, barn door latch, pool latch, sliding latch, hook and eye latch, flip latch, or the like. The gate and housing fasteners 28, 36 can be such as, for example, bolts, screws, rivets, anchors, or the like.

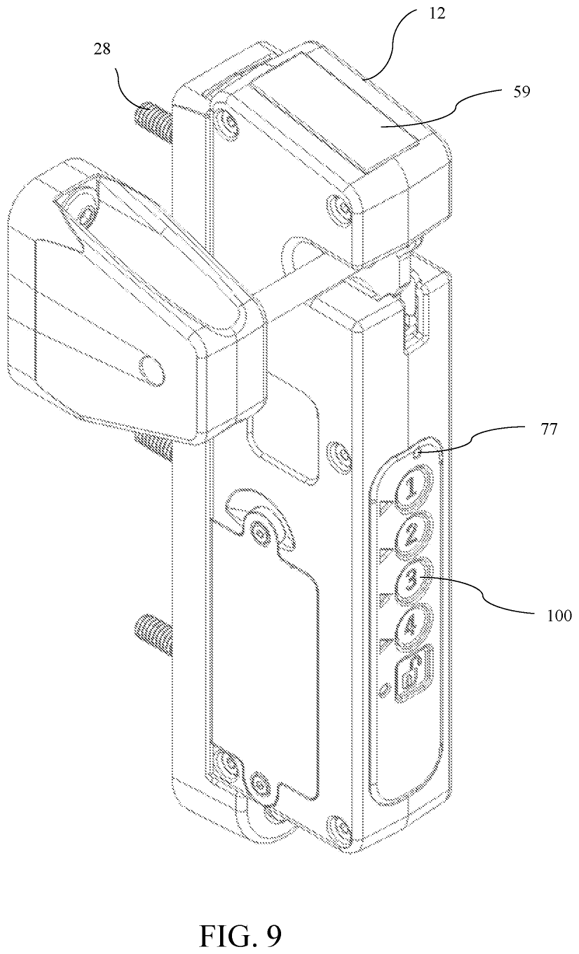

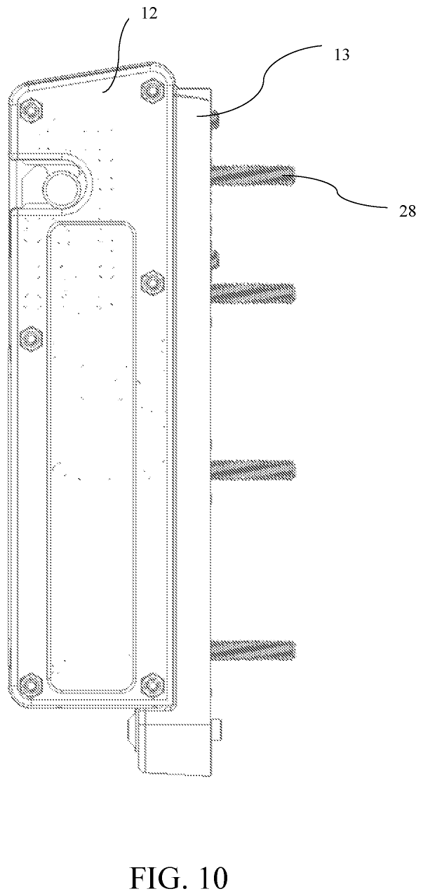

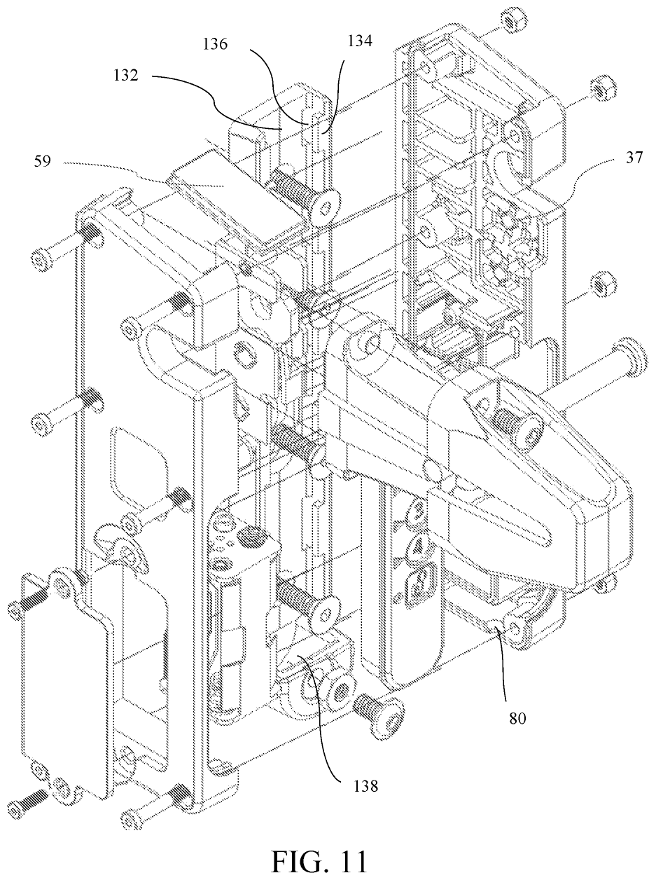

In some embodiments, the intelligent lock and latch system 10 can be attached to a post 30 by an adapter mount 13, best shown in FIGS. 9-11. The adapter mount 13 is first attached to the post 30 by a plurality of fasteners 28. The housing 12 is then attached to the adapter mount 13. The housing 12 may couple to the adapter mount 13 by use of a channel 132 and at least one wall 134. The housing 12 includes a plate 122 that is configured to fit into the channel 132 such that the walls 134 secure the plate 122 to the adapter mount 13. The plate 122 may have a “T” shape that fits into side slots 136 of the channel 132. The plate 122 may be mechanically couple to or integral to the housing 12. The “T” plate 122 slides into the channel 132 until it rests on a base 138 to quickly and securely connect the housing 12 to the adapter mount 13.

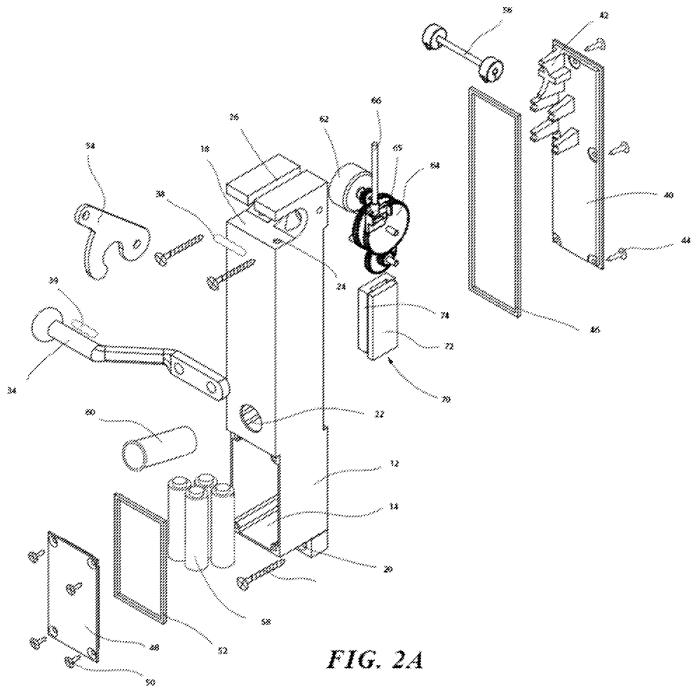

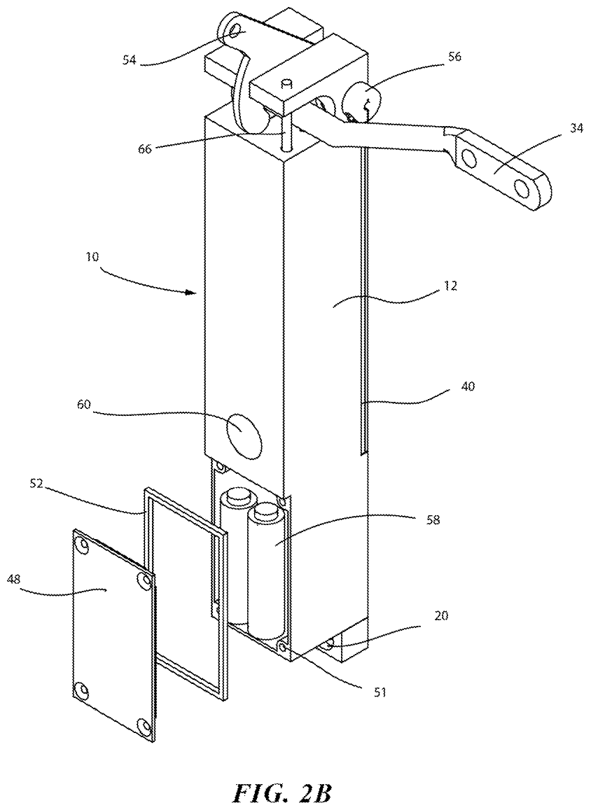

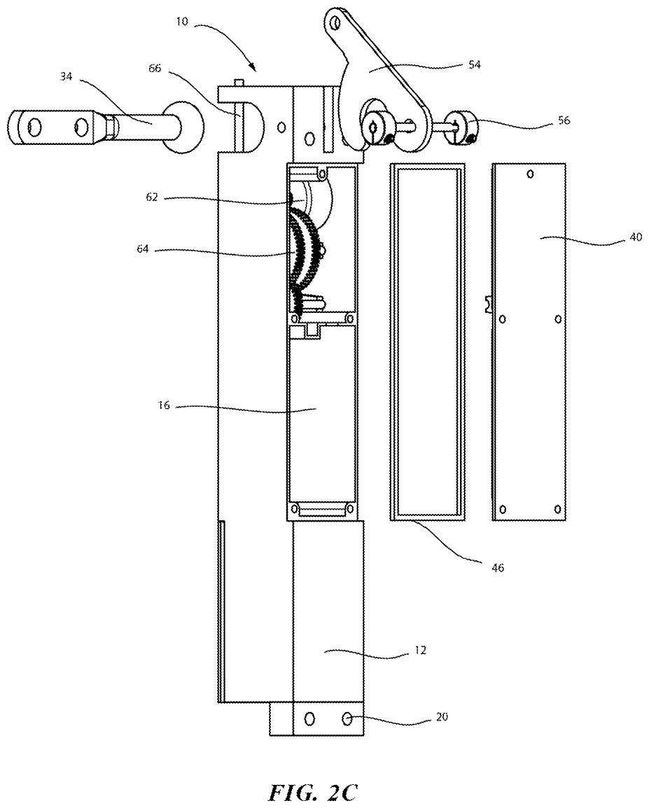

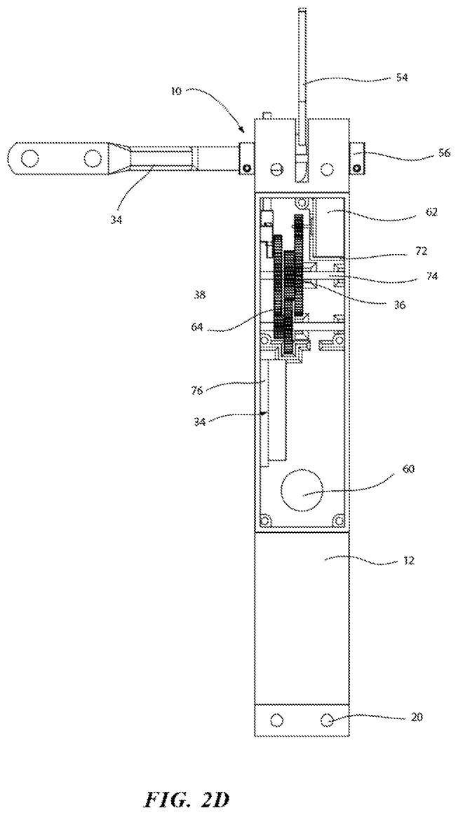

Referring to FIG. 2A-2D, the housing 12 can further comprise a front cavity 14, a back cavity 16, one or more mounting holes 20, a slot 26, and a recess 18. The housing can 12 be manufactured from plastics such as, for example, polyethylene terephthalate, high-density polyethylene, polyvinyl chloride, polypropylene, polylactic acid, nylon or the like, and/or metals such as, for example, stainless steel, aluminum, Inconel, carbon steel, or the like. The housing 12 can be a rectangular shape, or it can be circular, square, hexagonal, or the like in shape, and can have one or more cavities which can include one or more of the back cavity 12 and the front cavity 14. The housing 12 can be machined from a blank piece of material, or it can be injected molded, or casted.

The front cavity 14 can be at or near the bottom of the housing 12 wherein the front cavity can store a power supply wherein the power supply can be a plurality of batteries 58. The front cavity 12 can be sized to accommodate various type of battery 58 sizes such as, small coin cell batteries to large lithium ion batteries. The batteries 58 can be place into a sleeve which can be placed into the front cavity 14, or the batteries can freely float within the front cavity. The front cavity 14 can have one or more attachment points 51 at or near the outside edges for one or more fasteners 50 to attach a front cover 48 to. The front cavity 14 can be such as, rectangular, circular, square, hexagonal or the like in shape. In certain embodiments, the front cavity 14 can be omitted from the housing, or it can be placed on the back of the housing. The batteries 58 can be rechargeable, or replaceable, and can be such as, for example, nickel cadmium, nickel metal hydride, lithium ion, alkaline, nickel-zinc, or the like.

The front cover 48 can be attached to the front cavity 14 with one or more fasteners 50, and a front seal 52 can be placed between and/or compressed between the front cover, the housing 12 and the perimeter of the front cavity. The front cover 48, front seal 52, and front cavity 12 when attached together with fasteners 50 can keep fluids and dust from penetrating and entering the front cavity. The front seal 52 can be such as, for example, a gasket, o-ring, elastomeric overmolding, ultra-sonic welded, or the like. The front seal 52 can be removably or permanently attached to the housing 12, or the front cover 48, and can have a substantially similar shape as the front cavity 14. The front cover 48 can be manufactured from the same or similar materials and process as the housing 12.

The housing 12 can be coupled to the post 30 by one or more fasteners 28 through the housing's mounting holes 20 (as shown in FIG. 1). The mounting holes 20 can be located near the top and the bottom of the housing 12 wherein the bottom mounting holes can be exposed, or in some embodiments can be encapsulated within the front cavity 14. The mounting holes 20 located substantially near the top of the housing can be within the recess 18 or have a flange the extends beyond the top of the housing for the mounting holes 20 wherein the fasteners 28 can be inserted into and attached to the latch post 30 (as shown in FIG. 1). In some embodiments, the mounting holes 20 and the fasteners 28 near the top and bottom of the housing 12 can be enclosed with a cover, or encapsulated within the housing cavities. The fasteners 28 can be such as, for example, screws, bolts, rivets, pins, nails, carriage bolts, or the like.

The recess 18 can be substantially near the top of the housing 12 and can have a top and a bottom surface with a radius being substantially larger diameter as the latch pin 34 wherein the latch pin can slide into the recess and can be locked into position by a gravity latch 54. The recess 18 can have a bottom surface, and a top surface and a sensor cavity 37 for a sensor 38 to attach to, which can monitor the location of the latch pin 34. The latch pin 34 can have a magnet 39 attached to it which can activate the sensor when it is in close proximity allowing the user to know whether the latch pin is in an open or closed state. In other embodiments, the magnet can be omitted and the latch pin 34 can have a surface wherein a sensor such as a proximity sensor can read a return signal from the latch pin. The sensor cavity 37 can be substantially at or near the top or bottom of the recess, and substantially near the back of the recess 18. In certain embodiments, the sensor 38 can be placed in the back cavity, and the magnet can be on or in a locking pin 66, and or a gear 64 monitoring the distance traveled, and state of the locking pin. The sensor 38 can be such as, for example, hall effect sensor, infrared, capacitive, photoelectric, proximity, inductive, or the like. The recess 18 can have the locking pin hole 24 located on its bottom surface which can be a thru hole to the back cavity 16, wherein the locking pin hole can allow a locking pin 66 to trap, and/or lock the locking pin into the recess. The locking pin hole 24 can be sized to allow the locking pin 66 to slide up and down in the locking pin hole wherein the locking pin can be such as, for example, between 0.0625 inches and 0.250 inches, more preferably a width of between 0.09375 inches and 0.1875 inches, and still more preferably a width of approximately 0.125 inches or the like.

The slot 26 can extend from the top of the housing 12 to the recess 18 wherein the slot can be sized to accommodate a gravity latch 54 wherein the gravity latch can move freely up and down to release or trap the latch pin 34 within the recess. The gravity latch 54 can pivot on a pivot pin 56 which can be attached to and/or connected to the housing 12 through a support pin hole 68. The pivot pin 56 can be for example, a dowel pin, a bolt, a slotted pin, a coiled pin, a shoulder bolt, or the like which the support pin hole 68 can be sized to be an interference fit, clearance fit, or transition fit for the pivot pin 56 wherein if the fit is loose the support pin can either screw into one side of the housing, or the support pin can have a bolt and nut combination or the housing can be threaded, or the support pin can have clamps on the end locking the support pin in place. The support pin hole 68 can be such as, for example, between 0.0625 inches and 0.250 inches, more preferably a width of between 0.09375 inches and 0.1875 inches, and still more preferably a width of approximately 0.125 inches or the like. In certain embodiments, a housing 12 can fit around an existing latch 34, or can be installed on an existing latch wherein the housing can have a slot or recess that the can slide over, or can be placed around the latch allowing the latch to remain attached to the gate, and allowing the housing to be fastened to the gate or fence over the current latch system.

The housing 12 can further comprise a push button hole 22 wherein the push button hole can be on the front surface of the housing. The push button hole 22 can be sized to accommodate a push button 60 wherein the push button can be such as, for example, a momentary switch, toggle switch, selector switch, proximity switch, pressure switch, or the like. The push button can be controlled by the user wherein when it is pushed it can activate a motor 62, and the gears 64 can move the locking pin 66. In an alternative embodiment, the motor 62 can engage a cam 65 to move the locking pin 66. The user can set the time window or limit the time of use within a mobile application or computing device wherein the push button can be active, when outside of the time window the push will not activate the motor 62 and gears 64. In some embodiments, the push button 60 and the push button hole 22 can be omitted and the push button can be replaced with radio-frequency identification, Bluetooth Low Energy, Wi-Fi, near-field communication, or the like.

The back cavity 16 can comprise a motor mount 63, one or more gear supports 69, and an electronic mount 76. The back cavity 16 can be on the back of the housing 12 and extend from just below the recess 18 to just above the front cavity 14 wherein the back cavity and front cavity can be two separate compartments, or the cavities can be one large compartment, or two or more compartments. In certain embodiments, the back cavity 16 can be omitted and can be on the front of the housing 12. A motor 62 can be attached to or connected to the motor mount 63 by one or more fasteners, or it can snap onto the motor mount. The motor's 62 shaft can be connected to one of the gears 64. The motor 62 can be such as, for example, DC motor, step motor, brushless motor, brushed motor, AC motor, synchronous, asynchronous, or the like. The one or more gears 64 can be a gear reduction system wherein the gears can reduce the motor's rotation per second by such as, for example, 1:1, 2:1, 3:1, 4:1, 5:1, 10:1, 20:1, 30:1 or the like. In some embodiments, the motor 62 can have internal gear reduction system, or can be a magnetic motor/mechanism that lifts, lower and locks the locking pin 66 in place. The gears 64 can be placed on, and/or supported by one or more gear supports 69 wherein the gear supports can hold the gears in place and allow the gears to rotate freely has the motor turns the gears. The gears 54 can have be such as, for example, 30 teeth, 35 teeth, 40 teeth, 45 teeth, 50 teeth, 55 teeth, 60 teeth, 65 teeth, 70 teeth, or the like and can be single deck gear, double deck gear, helical gear, bevel gear, worm gear, spur gear or the like.

The locking pin 66 can be attached to one of the gears 64 by a locking pin adapter 65 which can lock the pin onto the gear wherein the motor 62 can turn the gears activating the locking pin through the locking pin hole 24, and locking or trapping the latch pin 34 within the recess. The locking pin 66 and the locking pin hole 24 can be sealed with a locking pin seal (not shown) wherein the locking pin seal can keep fluids and dust from penetrating the inside of the housing. The locking pin can be such as, for example, a dowel pin, a pin, threaded rod, metal rod, shafts, plastic rods, or the like. The locking pin seal (not shown) can be such as, for example, O-ring seal, gasket seal, ring seal, grommet, sealing washer, or the like. The locking pin 66 can be manufactured from materials such as, for example, stainless steel, aluminum, carbon steel, or the like, or plastic materials such as polyethylene terephthalate, high-density polyethylene, polypropylene, acrylonitrile butadiene styrene, or the like. In certain embodiments, the locking pin 66 can be locking into place with a dial lock, padlock or the like, or other embodiments the locking pin can be omitted and the latch pin 34 can be locked or trapped onto the housing 12 with an on/off magnet and magnetic switch within the housing and the latch pin, or can be locked into place with two or more locking pins 66. In another embodiment, the locking pin 66 can be locked into place by a linear solenoid with a rod wherein the solenoid can trap the gear and/or locking pin in its open or closed state.

The intelligent lock and latch system 10 can further comprise a back cover 40 wherein the back cover can comprise of back cover gear supports 42 and fastener holes, wherein the back cover gear supports can mate up with and/or connect to the gear supports 69 within the housing 12. In some embodiments, the back cover gear supports 42 can be omitted from the back cover 40. The back cover 40 can be connected to the housing 12 by one or more back cover fasteners 44 and the back cover can have a back seal 46 placed between itself and the housing to keep fluids from getting into the back cavity. The back cover seal 46 can be made from the same materials and properties as the front cover seal 52. The back seal 52 can be removably or permanently attached to the housing 12, or the back cover 40, and can have a substantially similar shape as the back cavity 16. The back cover fasteners 44 can be such as, for example, bolts, screws, rivets, or the like.

An electrical system 70 can be attached to the electrical support 76 wherein the electrical support can be part of the back cavity 16 within the housing's 12 mold or can be a separate piece that can be attached through fasteners to the housing 12. The electrical system 70 can comprise, but is not limited to, a power source such as a battery 58 or a solar panel 59, a printed circuit board 74 (“pcb”), microcontroller (“mcu”), Bluetooth module, an H-bridge, a memory module, and an RF-transmitter/receiver. In some embodiments, the electrical system 70 can comprise of accelerometer, temperature sensor, humidity sensor, atmospheric sensor, or the like. The electrical system 70 can transmit updates and notifications to the user or to a home hub, and can receive updates to the firmware. The electrical system 70 can connect directly to a home hub or to a mobile device which can have a mobile application on it that can receive notifications from the home hub or directly from the electrical system itself. The RF transmitter/receiver can communicate with a home hub or a mobile device. The notifications that the electrical system 70 can send to the user are, for example, history of gate openings, status of gate such as whether it is open or closed or when the gate was open and not shut, who has accessed the gate, whether the gate was disturbed, or the like.

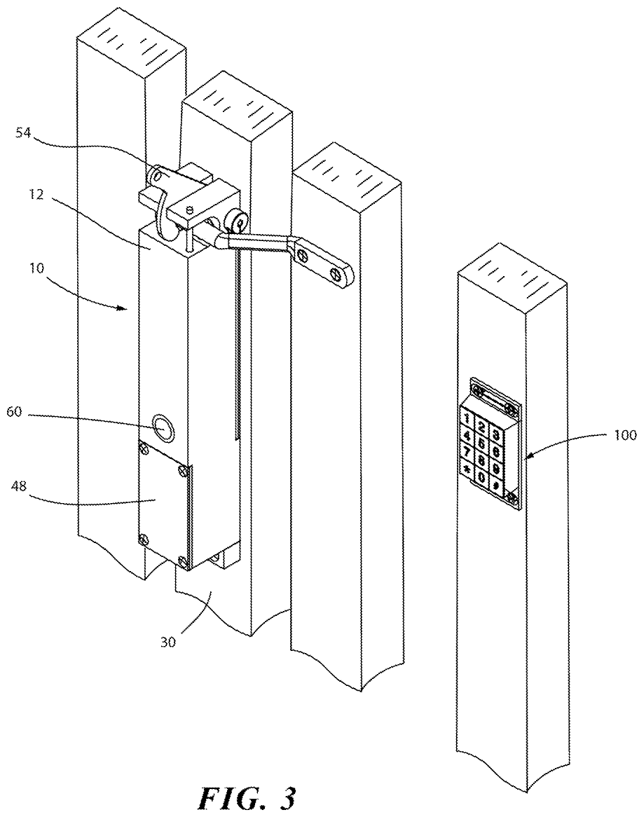

Referring to FIGS. 3 and 9, the intelligent lock and latch system 10 can further comprise a keypad 100 wherein the keypad can be a standalone system that can communicate through wireless communication to the electronics within the intelligent lock and latch system. The keypad 100 can communicate to the intelligent lock and latch system 10 through such as, for example, Bluetooth Low Energy, Wi-Fi, Bluetooth, or RF-transmitter/receiver, infrared, the like. The keypad 100 can have such as, for example, a digital keypad, an analog keypad, membrane keypad, capacitive keypad, dome-switch keypad, or the like. The keypad 100 can be powered by a battery having the same properties as the intelligent lock and latch system battery 58 (as shown in FIG. 2B) or by the solar panel 59. The keypad 100 can be attached to a post 30, or a gate 32 by one or more fasteners. In some embodiments, the keypad 100 can have its own electronics that can store the code, and in other embodiments the keypad can be omitted from the system.

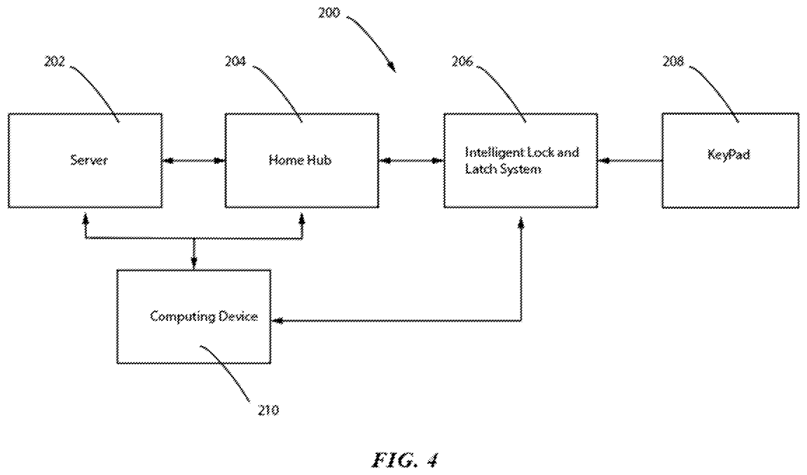

Referring to FIG. 4. a flow diagram of an intelligent lock and latch system shown generally at 200. At 208, a user can input a code into a keypad wherein the code can be multi-digit code that can be stored on the intelligent lock and latch system, or it can be stored on the home hub. A user can set or update the code on a computing device 210 wherein the computing device can have a mobile application installed on it that can be programmed to send the set or updated code to the intelligent lock and latch system or the home hub 204. The intelligent lock and latch system 206 can communicate with the home hub 204 with a wireless communication module such as, for example, RF-radio, Bluetooth module, Bluetooth Low Energy, Wi-Fi, or the like. The home hub 204 can receive the wireless communications from the intelligent lock and latch system 206 and/or the computing device 210. The home hub 204 can be plugged into a conventional 110V or 220V wall outlet.

The home hub 204 can comprise a microcontroller or a microcomputer that can either wirelessly communicate to a server 202, or be hard wired to the server. The home hub 204 can receive the data from a computing device 210 or the server 202 which can receive its data from a computing device. The home hub 204 can be the connection point with the user using the mobile application on a computing device 210. The home hub 204 can communicate with and send commands to the intelligent lock and latch system 206 wherein the intelligent lock and latch system does not need to store any information on the system itself. In other embodiments, the intelligent lock and latch system 206 can store the commands and send the notifications to the home hub 204, and in other embodiments the home hub can be omitted and the intelligent lock and latch system can connect directly to the server 202. The home hub 204 can store, send and receive commands to and from the computing device 210 and the intelligent lock and latch 206 such as, for example, user notification of status of the lock, last operation performed, last operation performed with its remaining power if batteries have died, battery status of the intelligent lock and latch system, battery status of keypad, gate movement, temperature, humidity, or the like.

The intelligent lock and latch system 206 can store a function on its memory medium or microcontroller wherein if the intelligent lock and latch system is low on battery, then it will send a notification through the home hub 204, or directly to a computing device 210 wherein the intelligent lock and latch system will unlock itself as its last operation with its remaining power. The intelligent lock and latch system 206 can store the code, and the last action performed by the user. In certain embodiments, the intelligent lock and latch system can store such as, for example, temperature, pressure, movement, keypad code, user's last known input, or the like, and send to home hub 204, or the computing device 210. The user through a computing device can lock or unlock the intelligent lock and latch system 10, can notify the user when the gate open or shut, and create user profile for one or more people such as family, friends, neighbors, service contractors, delivery people, or babysitters wherein each individual can have a unique code and/or profile set, and the user can be notified when the unique code is used. The user can turn on, off, or take away access from the other user.

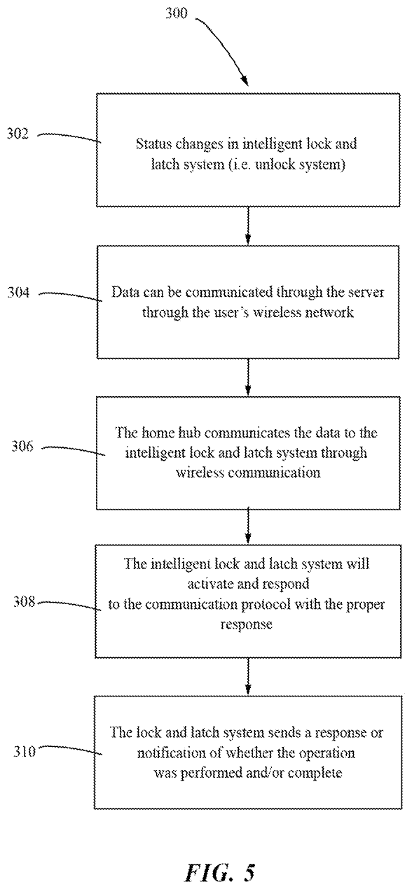

Referring to FIG. 5, an example flow diagram of an intelligent lock and latch system shown generally at 300. At step 302, the status changes in the intelligent lock and latch system or from the user's mobile device such as, for example, user send a command to unlock the system, to lock the system, status of gate whether it is open or closed, if there is movement at the gate, or the like. At step 304, the data can be communicated through the server through the user's wireless network. At step 306, the home hub communicates the data to the intelligent lock and latch system through the wireless communication modules. At step 308, the intelligent lock and latch system will activate and respond to the communication protocol with the proper response. At step 310, the intelligent lock and latch system can send a response or notification of whether the operation was performed and/or completed.

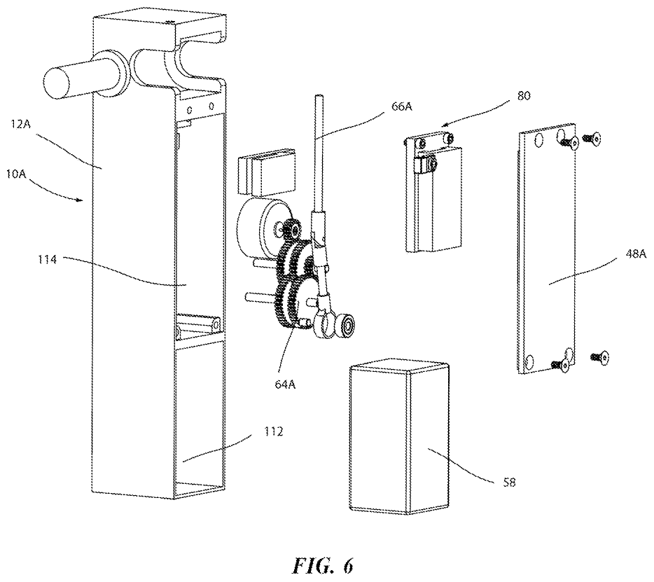

Referring to FIG. 6, shows another embodiment of an intelligent lock and latch system shown generally at 10A. The intelligent lock and latch system 10A can comprise a housing 12A wherein the housing can have two cavities on the same side of the housing having a top cavity 114, and a bottom cavity 112. The top cavity can store the electrical system 70, one or more gears 64A, the motor 62, and the locking pin 66A wherein the locking pin can be attached to the gears by an adapter 65 and a bearing 67. The bottom cavity 112 can store the batteries 58. A cover 48A can seal the cavities and keep fluids and dust out.

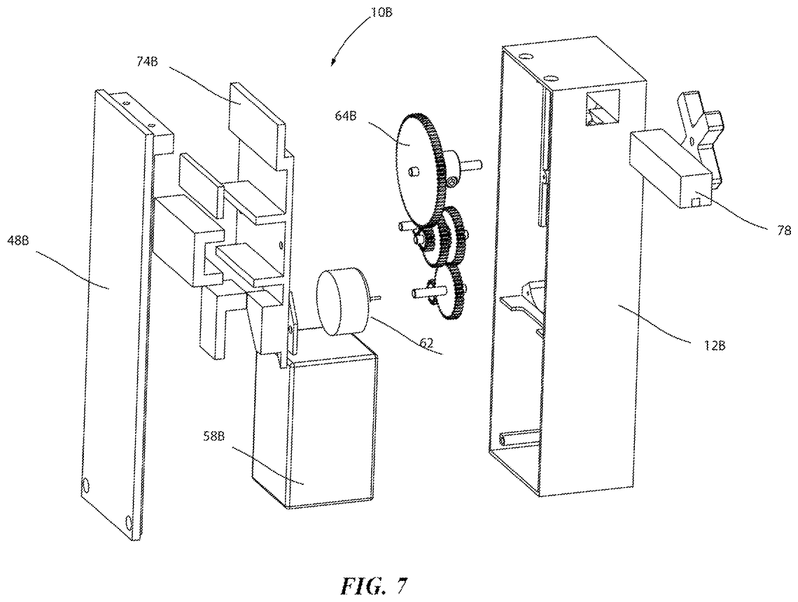

Referring to FIG. 7, shows another embodiment of an intelligent lock and latch system shown generally at 10B. The intelligent lock and latch system 10B can comprise a housing 12B wherein the housing can have two cavities on the same side of the housing having a top cavity 114, and a bottom cavity 112. The top cavity can store the electrical system 70, one or more gears 64B, gear supports 69B, the motor 62, and the sliding lock 78 wherein the sliding lock can be connected to or touch the gears wherein the gears can slide the sliding lock in and out of the housing. The bottom cavity 112 can store the batteries 58.

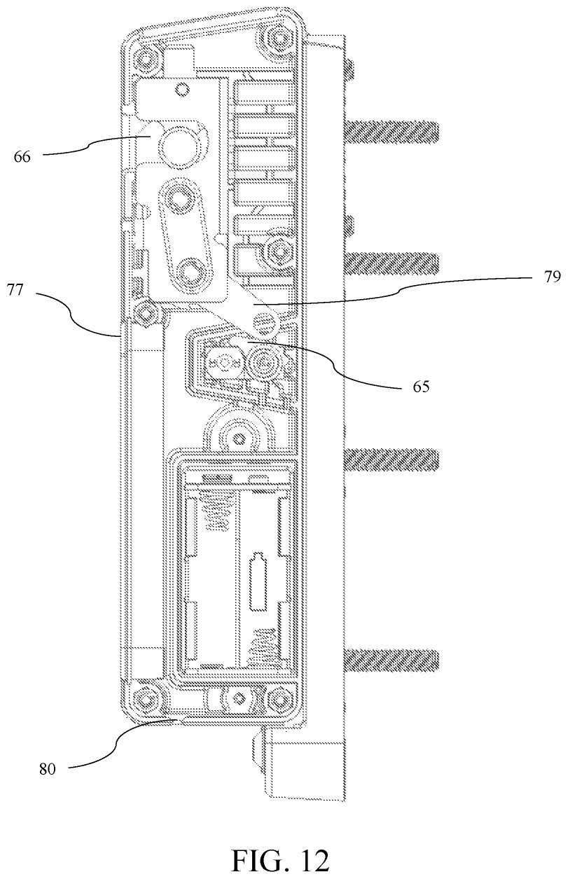

Referring to FIGS. 9 and 12, in particular embodiments, the latch system 10 can include a failsafe 77 to allow access to open a locked latch system 10 in the event of a power outage or other catastrophic failure of the latch system 10. The failsafe allows a failsafe pin (not shown) to be inserted through the failsafe into the housing 12. The failsafe pin (not shown) can operate a lever 79 to move the locking pin 66. The failsafe 77 and failsafe pin (not shown) may be shaped to only allow a particularly shaped failsafe pin to operate like a key to only allow the user to operate the failsafe 77 of the latch system 10.

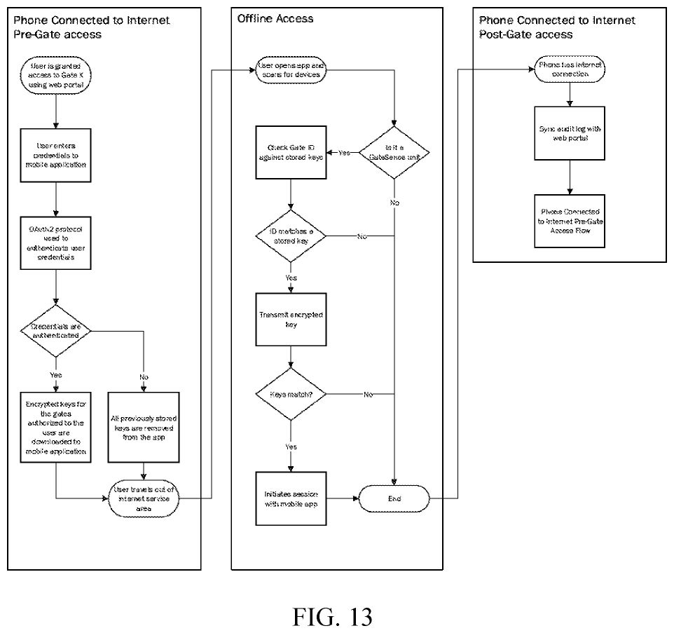

Referring to FIG. 13, an example flow diagram of an intelligent lock and latch system shown generally at 400. At step 402, a user is granted access to the gate lock via a web portal. At step 404, the user enters credentials to a mobile application on a mobile device such as a tablet or cell phone. At step 406, a protocol is used to authenticate the user's credentials. If the user's credentials are authenticated, at step 408 encrypted keys for the gates authorized to the user are downloaded to mobile application. If the user's credentials are not authenticated, at step 410, all previously stored keys are removed from the app. If the user is outside of an internet service area, at figure 412 the user opens the app and the user's mobile device is instructed to scan for devices. If the user's mobile device detects a gate latch system, at step 414 the gate ID of the gate latch system is checked against stored keys. If the ID matches a stored key, an encrypted key is transmitted to the gate latch system. At step 416 the gate latch system checks the encrypted key for a match and initiates a session with the user's mobile app at step 418 if the keys match. When the mobile device enters an internet service area again, the audit log of the mobile app is synced with the web portal at step 420 and the mobile device is connected to the internet pre-gate access flow.

The latch system 10 is designed to be impervious to the elements. The housing 12 can be essentially waterproof. In a particular embodiment, the all electronics are potted to prevent shorting due to water, and the housing 12 includes a drain 80 to allow water that has entered the housing 12 to leave the housing 12 to prevent corrosion.

In closing, it is to be understood that although aspects of the present specification are highlighted by referring to specific embodiments, one skilled in the art will readily appreciate that these disclosed embodiments are only illustrative of the principles of the subject matter disclosed herein. Therefore, it should be understood that the disclosed subject matter is in no way limited to a particular methodology, protocol, and/or reagent, etc., described herein. As such, various modifications or changes to or alternative configurations of the disclosed subject matter can be made in accordance with the teachings herein without departing from the spirit of the present specification. Lastly, the terminology used herein is for the purpose of describing particular embodiments only, and is not intended to limit the scope of the present disclosure, which is defined solely by the claims. Accordingly, embodiments of the present disclosure are not limited to those precisely as shown and described.

Certain embodiments are described herein, including the best mode known to the inventors for carrying out the methods and devices described herein. Of course, variations on these described embodiments will become apparent to those of ordinary skill in the art upon reading the foregoing description. Accordingly, this disclosure includes all modifications and equivalents of the subject matter recited in the claims appended hereto as permitted by applicable law. Moreover, any combination of the above-described embodiments in all possible variations thereof is encompassed by the disclosure unless otherwise indicated herein or otherwise clearly contradicted by context.

What is claimed is:

1. An intelligent latch and lock system for use with a latch pin secured to a gate, the system comprising:
a housing that is securable to the post, said housing having a recess to accommodate the latch pin and a cutout to accommodate the gravity latch;
a locking pin that selectively transverses the recess to prevent the latch pin from exiting the recess; and
electronics coupled to the locking pin to control the position of the locking pin.

2. An intelligent latch and lock system according to claim 1, wherein the housing further comprises a back cavity encompassing a motor powered by the electronics and coupled to the locking pin to selectively move the locking pin from an open position to a locked position.

3. An intelligent latch and lock system according to claim 2, wherein the housing can further comprise a front cavity accessible to a user when the housing is secured to the post.

4. An intelligent latch and lock system according to claim 3, wherein the housing further comprises a failsafe hole configured to allow a failsafe pin to operate the locking pin.

5. An intelligent latch and lock system according to claim 3, wherein the front cavity and the back cavity are sealed shut with a front seal and a front cover, and a back seal and a back cover wherein the front cover and back cover are fastened to the housing.

6. An intelligent latch and lock system according to claim 1, wherein the electronics are potted and wherein the housing comprises a drain to allow water that enters the housing to leave the housing.

7. An intelligent latch and lock system according to claim 1, wherein the electronics connect remotely to at least one of a home hub and a computing device.

8. An intelligent latch and lock system according to claim 1, wherein the electronics connect remotely to a user's mobile device, wherein the user's mobile device has credentials, and wherein the credentials are verified with an encrypted key.

9. An intelligent latch and lock system according to claim 1, wherein the electronics are powered at least in part by a solar panel.

10. An intelligent latch and lock system according to claim 1, wherein the housing is detachably coupled to an adapter mount.

11. An intelligent latch and lock system according to claim 1, wherein the user controls the latch and lock system from a mobile app on the user's mobile device.

12. A system for controlling access to multiple access gates, comprising,
a plurality of latch and lock systems, each latch and lock system comprising:
a latch pin secured to a gate,
a housing that is securable to the post and having a recess to accommodate the latch pin;
a locking pin that selectively transverses the recess to prevent the latch pin from exiting the recess; and
electronics coupled to the locking pin to control the position of the locking pin wherein the electronics connects remotely to a user's mobile device;
wherein the user's mobile device has credentials, and wherein the credentials allow the user to operate at least one of the plurality of latch and lock systems.

13. A method of controlling a latch and lock system, comprising:
securing a latch pin to a gate;
securing a housing having a recess to accommodate the latch pin to a post, the housing having a locking pin that is electronically controlled to selectively transverse the recess to prevent the latch pin from exiting the recess;
situating the latch pin within the recess; and
activating electronics to move the locking pin to transverse the recess to prevent the latch pin from exiting the recess.

14. The method of claim 13, wherein the electronics are activated remotely from a user's mobile device.

15. The method of claim 14 wherein the mobile device has credentials, the method further comprising:
transmitting the credentials to the electronics;
verifying the credentials with an encrypted key; and
allowing the mobile device to operate the electronics based on the verification of the credentials.

16. The method of claim 13, wherein the electronics are activated remotely from at least one of a home hub and a computing device.
